(19) United States
(12) Patent Application Publication
(10) Pub. No.: US 2009/0131585 A1
(43) Pub. Date: May 21, 2009

(54) Organosilicon Compounds and Their Use In Crosslinkable Compositions

(75) Inventor: Marko Prasse, Glaubitz (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/957,673

(22) Filed: Dec. 17, 2007

(30) Foreign Application Priority Data
Dec. 27, 2006 (DE) 10 2006 061 584.0

(51) Int. Cl. C08L 83/06; C07F 7/02

(52) U.S. Cl. 524/861; 556/443

(57) ABSTRACT

Organosilicon compounds having units of the formula

R_{d}XₑSiY_{(4-d-e)/2} (I),

where X is OH or a hydrolyzable radical and Y is a divalent hydrolyzable radical are useful in crosslinkable compositions, in particular in compositions crosslinkable via a condensation reaction, preferably as sealing compounds.

### BACKGROUND OF THE INVENTION

1. Field of the Invention

The invention relates to organosilicon compounds and to their use in crosslinkable compositions, in particular in compositions crosslinkable via a condensation reaction. The compositions are preferably used as sealing compounds.

2. Background Art

Single-component sealing compounds which are storable if water is excluded but on ingress of water at room temperature vulcanize to give elastomers are known. The construction industry, for example, uses large quantities of these products. These mixtures are based on polymers terminated by silyl groups, where these bear reactive substituents, such as OH groups or hydrolyzable groups, e.g. alkoxy groups, and also on a crosslinking agent, e.g. alkoxysilanes.

Especially for jointing compositions, it is desirable that the environment of the joints is not hydrophobized. This is particularly true for applications in contact with natural stone and glass. Uniform hardening throughout the material with no gradient is moreover desirable.

### SUMMARY OF THE INVENTION

Organosilicon compositions particularly useful for jointing compounds contain as one crosslinker an organosilicon compound containing difunctional hydrolyzable groups. The compositions exhibit good adherence to substrates while avoiding hydrophobicizing the area around the joint.

### DETAILED DESCRIPTION OF THE PREFERRED EMBODIMENT(S)

The invention thus provides organosilicon compounds containing units of the formula

R_{d}XₑSiY_{(4-d-e)/2} (I),

where
R can be identical or different, and are monovalent, optionally substituted hydrocarbon radicals which can be interrupted by oxygen atoms,
X can be identical or different, and are hydroxy groups or monovalent, hydrolyzable radicals,
Y can be identical or different, and are —O— or a difunctional hydrolyzable radical,
d is 0, 1, 2 or 3, preferably 0 or 1, and
e is 0, 1, 2 or 3, preferably 0, 1 or 2,
with the proviso that d+e≦3, from 2 to 100 units of the formula (I) are present per molecule, and at least one radical Y which is a difunctional hydrolyzable radical and at least one radical X are present per molecule.

The inventive organosilicon compounds preferably contain at least two radicals X, more preferably at least three radicals X, where X has one of the abovementioned definitions.

In the inventive organosilicon compounds it is preferable to include at least 10%, more preferably from 20 to 50%, of radicals Y which are a difunctional hydrolyzable radical.

The radical R is preferably a monovalent hydrocarbon radical having from 1 to 18 carbon atoms and optionally substituted by groups having oxygen atoms and/or by groups having nitrogen atoms, and is more preferably an alkyl radical, vinyl radical, phenyl radical, aminopropyl radical, aminoethylaminopropyl radical, glycidoxypropyl radical, O-methylcarbamatomethyl radical, morpholinomethyl radical, phenylaminomethyl radical or cyclohexylaminomethyl radical, in particular a methyl, vinyl or aminopropyl radical.

Examples of radicals R are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals; hexyl radicals such as the n-hexyl radical; heptyl radicals such as the n-heptyl radical; octyl radicals such as the n-octyl radical and isooctyl radicals such as the 2,2,4-trimethylpentyl radical; nonyl radicals such as the n nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, cycloheptyl and methylcyclohexyl radicals; alkenyl radicals such as the vinyl, 1-propenyl and 2-propenyl radicals; aryl radicals such as the phenyl, naphthyl, anthryl, and phenanthryl radical; alkaryl radicals such as o-, m-, and p-tolyl radicals, xylyl radicals and ethylphenyl radicals; and aralkyl radicals such as the benzyl radical and the α- and the β-phenylethyl radicals.

Examples of radicals X are hydroxy, acetoxy, oximato radicals and organyloxy radicals —OR¹, where R¹ is monovalent, optionally substituted hydrocarbon radical which may be interrupted by oxygen atoms, e.g. methoxy radicals, ethoxy radicals, alkoxyethoxy radicals, and hydroxy-containing radicals such as the 2-hydroxypropoxy, 2-hydroxy-1-methylpropoxy, 2-hydroxybutoxy, 1-hydroxy-2-methylethoxy- and 2-hydroxy-ethoxy radicals. Examples of radicals R¹ are the radicals given for R. Radical X is preferably an organyloxy radical —OR¹, where R¹ is as defined above, particular preference being given to the methoxy and ethoxy radicals, in particular the methoxy radical. It is preferable that at most 30%, more preferably at most 20%, of the radicals X are hydroxy groups.

Examples of radicals Y are —O— and divalent organyloxy radicals —OR²O—, where R² is divalent, optionally substituted hydrocarbon radical, which can be interrupted by oxygen atoms.

Examples of radicals R² are ethylene, propylene and butylene radicals, and also hydrocarbon radicals interrupted by oxygen atoms, e.g. —CH₂CH₂—O—(CH₂CH₂O)ₙ—CH₂CH₂—, where n is 0 or a whole number from 1 to 10, in particular 0 or a whole number from 1 to 3. Radical R² is preferably a divalent hydrocarbon radical having from 2 to 10 carbon atoms, optionally interrupted by oxygen atoms, more preferably —CH₂CH₂—(OCH₂CH₂)—, —CH(CH₃)CH₂—(OCH(CH₃)CH₂)—, —CH₂CH₂CH₂—(OCH₂CH₂CH₂)—, —CH(CH₃)CH(CH₃)—(OCH(CH₃)CH(CH₃))—, —CH(CH₂CH₃)CH₂—(OCH(CH₂CH₃)CH₂)—, —CH₂CH₂CH₂CH₂—(OCH₂CH₂CH₂CH₂)—, —CH₂CH₂CH(CH₃)—(OCH₂CH₂CH(CH₃))—, and —CH₂CH(CH₃)CH₂—(OCH₂CH(CH₃)CH₂)—, where each n is 0, 1 or 2.

Radical Y is preferably one of the radicals —O—, —O—CH₂CH₂—(OCH₂CH₂)ₙ—O—, —OCH(CH₃)CH₂—(OCH(CH₃)CH₂)ₙ—O—, —OCH₂CH₂CH₂—(OCH₂CH₂CH₂)ₙ—O—, —OCH(CH₃)CH(CH₃)—(OCH(CH₃)CH(CH₃))ₙ—O—, —OCH(CH₂CH₃)CH₂—(OCH(CH₂CH₃)CH₂)ₙ—O—, —OCH₂CH₂CH₂CH₂—(OCH₂CH₂CH₂CH₂)ₙ—O—, —OCH₂CH₂CH(CH₃)—(OCH₂CH₂CH(CH₃))ₙ—O—, —OCH(CH₃)CH(CH₃)—(OCH(CH₃)CH(CH₃))ₙ—O— and —OCH₂CH(CH₃)CH₂—(OCH₂CH(CH₃)CH₂)ₙ—O—, in particular the radical —OCH(CH₃)CH₂—(OCH(CH₃)CH₂)ₙ—O—, where each n is 0, 1 or 2.

The inventive organosilicon compound is preferably a compound which contains from 2 to 50, in particular from 2 to 15, units of the formula (I). The inventive organosilicon compound is more preferably a compound composed of units of the formula (I), and preferably are compounds which are liquid at room temperature and at the pressure of the ambient atmosphere, i.e. from 900 to 1100 hPa, and whose viscosity is preferably from 1.0 to 1000 mm²/s, more preferably from 2.0 to 10 mm²/s, in each case at 25° C. The flashpoint of the organosilicon compound is preferably from 15 to 200° C., more preferably from 15 to 100° C., in particular from 20 to 50° C., in each case determined to DIN 51 755 (Abel-Pensky). The inventive organosilicon compound can be linear, branched or cyclic, preferably linear or branched.

The inventive organosilicon compound is preferably a compound of the formula

[X_{g}R_{3-g}SiY_{1/2}—]ₚ[XᵢR₂₋ᵢSiY_{2/2}—]_{q}[XₘR₁₋ₘSiY_{3/2}—]ᵣ[SiY_{4/2}—]ₛ (II)

where
R, X and Y are respectively as defined above,
g is 0, 1, 2 or 3, preferably 2 or 3,
i is 0, 1 or 2, preferably 1 or 2,
m is 0 or 1,
p is 0 or a whole number from 1 to 10,
q is 0 or a whole number from 1 to 90,
r is 0 or a whole number from 1 to 10, and
s is 0 or a whole number from 1 to 10,
with the proviso that (p+q+r+s) is a number from 2 to 100, the distribution of the units can be random and at least one radical Y which is a difunctional hydrolyzable radical and at least one radical X are present per molecule.

Examples of the inventive organosilicon compounds are
(MeO)₂SiMe-[OCH(Me)CH₂O—SiMe(OMe)]₁₋₉₉(OMe),
(—OCH(Me)CH₂O—)SiMe-[OCH(Me)CH₂O—SiMe(OMe)]₁₋₉₉(OMe),
[—OCH(Me)CH₂O—SiMe(OMe)-]₂,
(MeO)₂SiVi-[OCH(Me)CH₂O—SiVi(OMe)]₁₋₉₉(OMe),
(—OCH(Me)CH₂O—)SiVi-[OCH(Me)CH₂O—SiVi(OMe)]₁₋₉₉(OMe),
(MeO)₂Si(CH₂CH₂CH₂NH₂)—[OCH(Me)CH₂O—Si(CH₂CH₂CH₂NH₂)(OMe)]₁₋₉₉(OMe),
(—OCH(Me)CH₂O—)Si(CH₂CH₂CH₂NH₂)—[OCH(Me)CH₂O—Si(CH₂CH₂CH₂NH₂)(OMe)]₁₋₉₉(OMe),
(MeO)₂Si(CH₂NH-cyc-hex)-[OCH(Me)CH₂O—Si(CH₂NH-cyc-hexyl)(OMe)]₁₋₉₉(OMe),
(—OCH(Me)CH₂O—)Si(CH₂NH-cyc-hexyl)-[OCH(Me)CH₂O—Si(CH₂NH-cyc-hexyl)(OMe)]₁₋₉₉(OMe),
(MeO)₂SiMe-[OCH(Me)CH₂O—Si(CH₂CH₂CH₂NH₂)(OMe)]₁₋₉₉(OMe),
(EtO)₂SiMe-[OCH(Me)CH₂O—SiMe(OEt)]₁₋₉₉(OEt),
(MeO)₃Si—[OCH(Me)CH₂O—Si(OMe)₂]₁₋₉₉(OMe),
(EtO)₃Si—[OCH(Me)CH₂O—Si(OEt)₂]₁₋₉₉(OEt),
(MeO)₂SiMe-[OCH₂CH₂O—SiMe(OMe)]₁₋₉₉(OMe),
(—OCH₂CH₂O—)SiMe-[OCH₂CH₂O—SiMe(OMe)]₁₋₉₉(OMe),
(MeO)₂SiMe-[OCH(Me)CH(Me)O—SiMe(OMe)]₁₋₉₉(OMe),
(—OCH(Me)CH(Me)O—)SiMe-[OCH(Me)CH(Me)O—SiMe(OMe)]₁₋₉₉(OMe),
(MeO)₂SiMe-[OCH(Me)CH₂OCH(Me)CH₂O—SiMe(OMe)]₁₋₉₉(OMe),
(—OCH(Me)CH₂OCH(Me)CH₂O—)SiMe-[OCH(Me)CH₂OCH(Me)CH₂O—SiMe(OMe)]₁₋₉₉(OMe),
(MeO)₂SiMe-[OCH(Me)CH₂O—SiMe(OMe)]₁₋₉₉(—OSiMe(OMe)₂),
(MeO)₂SiMe-[OCH(Me)CH₂O—SiMe(OMe)]₁₋₈₉(—OSiMe(OMe))₁₋₁₀(OMe),
(MeO)₃Si—[OCH(Me)CH₂O—Si(OMe)₂]₁₋₈₉(—OSi(OMe)₂)₁₋₁₀(OMe),
(MeO)₂Si(CH₂CH₂CH₂NH₂)—[OCH(Me)CH₂O—SiVi(OMe)]₁₋₉₉(—OSiMe(OMe)₂),
(MeO)₂SiVi-[OCH(Me)CH₂O—Si(CH₂CH₂CH₂NH₂)(OMe)]₁₋₈₉(—OSiMe(OMe))₁₋₁₀(OMe),
(EtO)₃Si—[OCH(Me)CH₂O—Si(OEt)₂]₁₋₈₉(—OSi(OEt)₂)₁₋₁₀(OEt),
(MeO)₂SiMe-[OCH(Me)CH₂O—SiMe(OMe)]₁₋₈₉(—OSiMe₂)₁₋₁₀(OMe),
(MeO)₂SiMe-[OCH(Me)CH₂O—SiMe(OMe)]₁₋₈₉(—OSiMe(OMe))₂ (SiMe(OMe)₂)₁,
[(MeO)₂SiMe(OCH(Me)CH₂O)_{1/2}]₁₋₂₅—[(OCH(Me)CH₂O)_{2/2}SiMe(OMe)]₁₋₅₀-[SiMe(OCH(Me)CH₂O)_{3/2}]₁₋₂₅,
[(MeO)₂SiVi(OCH(Me)CH₂O)_{1/2}]₁₋₂₅—[(OCH(Me)CH₂O)_{2/2}SiVi(OMe)]₁₋₅₀—[SiVi(OCH(Me)CH₂O)_{3/2}]₁₋₂₅,
[(MeO)₂Si(CH₂NHC(═O)OMe)(OCH(Me)CH₂O)_{1/2}]₁₋₂₅—[(OCH(Me)CH₂O)_{2/2}Si(CH₂NHC(═O)OMe)(OMe)]₁₋₅₀-[Si(CH₂NHC(═O)OMe)(OCH(Me)CH₂O)_{3/2}]₁₋₂₅,
[(EtO)₃Si(OCH(Me)CH₂O)_{1/2}]₁₋₃₀—[(OCH(Me)CH₂O)_{2/2}—Si(OEt)₂]₁₋₄₀-[Si(OEt)(OCH(Me)CH₂O)_{3/2}]₁₋₂₀—[Si(OCH(Me)CH₂O)_{4/2}]₁₋₅,
[(MeO)₃Si(OCH(Me)CH₂O)_{1/2}]₁₋₃₀—[(OCH(Me)CH₂O)_{2/2}—Si(OMe)₂]₁₋₄₀-[Si(OMe)(OCH(Me)CH₂O)_{3/2}]₁₋₂₀—[Si(OCH(Me)CH₂O)_{4/2}]₀₋₅ and
[(MeO)₃Si(OCH(Me)CH₂O)_{1/2}]₁₋₁₅-[(MeO)₃SiO_{1/2}]₁₋₁₅—[(OCH(Me)CH₂O)_{2/2}—Si(OMe)₂]₁₋₂₀—[O_{2/2}—Si(OMe)₂]₁₋₂₀—[Si(OMe)(OCH(Me)CH₂O)_{3/2}]₁₋₁₀—[Si(OMe)O_{3/2}]₁₋₁₀—[Si(OCH(Me)CH₂O)_{4/2}]₀₋₂—[SiO_{4/2}]₀₋₂,
   where Me is methyl radical, Et is an ethyl radical, -cyc-hexyl is a cyclohexyl radical and Vi is a vinyl radical.

The inventive organosilicon compounds are preferably
(MeO)₂SiMe-[OCH(Me)CH₂O—SiMe(OMe)]₁₋₉₉(OMe),
(—OCH(Me)CH₂O—)SiMe-[OCH(Me)CH₂O—SiMe(OMe)]₁₋₉₉(OMe),
(MeO)₂SiVi-[OCH(Me)CH₂O—SiVi(OMe)]₁₋₉₉(OMe),
(—OCH(Me)CH₂O—)SiVi-[OCH(Me)CH₂O—SiVi(OMe)]₁₋₉₉(OMe),
(EtO)₂SiMe-[OCH(Me)CH₂O—SiMe(OEt)]₁₋₉₉(OEt),
(MeO)₃Si—[OCH(Me)CH₂O—Si(OMe)₂]₁₋₉₉(OMe),
(EtO)₃Si—[OCH(Me)CH₂O—Si(OEt)₂]₁₋₉₉(OEt),
(EtO)₃Si—[OCH(Me)CH₂O—Si(OEt)₂]₁₋₈₉(—OSi(OEt)₂)₁₋₁₀(OEt),
(MeO)₂SiMe-[OCH(Me)CH₂O—SiMe(OMe)]₁₋₈₉(—OSiMe₂)₁₋₁₀(OMe),
(MeO)₂SiMe-[OCH(Me)CH₂O—SiMe(OMe)]₁₋₈₉(—OSiMe(OMe))₂ (SiMe(OMe)₂)₁,
[(MeO)₂SiMe-(OCH(Me)CH₂O)_{1/2}]₁₋₂₅-[(OCH(Me)CH₂O)_{2/2}SiMe(OMe)]₁₋₅₀-[SiMe(OCH(Me)CH₂O)_{3/2}]₁₋₂₅,
[(MeO)₂SiVi(OCH(Me)CH₂O)_{1/2}]₁₋₂₅—[(OCH(Me)CH₂O)_{2/2}SiVi(OMe)]₁₋₅₀-[SiVi(OCH(Me)CH₂O)_{3/2}]₁₋₂₅,
[(MeO)₂Si(CH₂NHC(═O)OMe)(OCH(Me)CH₂O)_{1/2}]₁₋₂₅—[(OCH(Me)CH₂O)_{2/2}Si(CH₂NHC(═O)OMe)(OMe)]₁₋₅₀-[Si(CH₂NHC(═O)OMe)(OCH(Me)CH₂O)_{3/2}]₁₋₂₅,
[(EtO)₃Si(OCH(Me)CH₂O)_{1/2}]₁₋₃₀—[(OCH(Me)CH₂O)_{2/2}—Si(OEt)₂]₁₋₄₀-[Si(OEt)(OCH(Me)CH₂O)_{3/2}]₁₋₂₀—[Si(OCH(Me)CH₂O)_{4/2}]₀₋₅,
[(MeO)₃Si(OCH(Me)CH₂O)_{1/2}]₁₋₃₀—[(OCH(Me)CH₂O)_{2/2}—Si(OMe)₂]₁₋₄₀-[Si(OMe)(OCH(Me)CH₂O)_{3/2}]₁₋₂₀—[Si(OCH(Me)CH₂O)_{4/2}]₀₋₅ and
[(MeO)₃Si(OCH(Me)CH₂O)_{1/2}]₁₋₁₅-[(MeO)₃SiO_{1/2}]₁₋₁₅—[(OCH(Me)CH₂O)_{2/2}—Si(OMe)₂]₁₋₂₀—[O_{2/2}—Si(OMe)₂]₁₋₂₀—[Si(OMe)(OCH(Me)CH₂O)_{3/2}]₁₋₁₀—[Si(OMe)O_{3/2}]₁₋₁₀—[Si(OCH(Me)CH₂O)_{4/2}]₀₋₂—[SiO_{4/2}]₀₋₂,
   where Me is methyl radical, Et is an ethyl radical and Vi is a vinyl radical.

The inventive compounds are more preferably (MeO)₂SiMe-[OCH(Me)CH₂O—SiMe(OMe)]₁₋₅₀(OMe), (MeO)₂SiVi-[OCH(Me)CH₂O—SiVi(OMe)]₁₋₅₀(OMe), (MeO)₃Si—[OCH(Me)CH₂O—Si(OMe)₂]₁₋₉₉(OMe), (EtO)₃Si—[OCH(Me)CH₂O—Si(OEt)₂]₁₋₅₀(OEt), [(MeO)₂SiMe(OCH(Me)CH₂O)_{1/2}]₁₋₁₀—[(OCH(Me)CH₂O)_{2/2}SiMe(OMe)]₁₋₂₀-[SiMe(OCH(Me)CH₂O)_{3/2}]₁₋₈, [(MeO)₂Si(CH₂NHC(═O)OMe)(OCH(Me)CH₂O)_{1/2}]₁₋₁₀—[(OCH(Me)CH₂O)_{2/2}Si(CH₂NHC(═O)OMe)(OMe)]₁₋₂₀-[Si(CH₂NHC(═O)OMe)(OCH(Me)CH₂O)_{3/2}]₁₋₈ and [(EtO)₃Si(OCH(Me)CH₂O)_{1/2}]₁₋₁₂—[(OCH(Me)CH₂O)_{2/2}—Si(OEt)₂]₁₋₂₀—[Si(OEt)(OCH(Me)CH₂O)_{3/2}]₁₋₅—[Si(OCH(Me)CH₂O)_{4/2}]₁₋₃, in particular ([(MeO)₂SiMe(OCH(Me)CH₂O)_{1/2}]₁₋₁₀—[(OCH(Me)CH₂O)_{2/2}SiMe(OMe)]₁₋₂₀-[SiMe(OCH(Me)CH₂O)_{3/2}]₀₋₈, where Me is a methyl radical, Vi is a vinyl radical and Et is an ethyl radical.

The inventive organosilicon compounds can be prepared by any of the widely known methods, e.g. via esterification of silanes having three and/or four hydrolyzable groups with alcohols and with diols. Partial hydrolysis is also possible, and/or silanes having one and/or two hydrolyzable groups may be present.

It is preferable that the inventive organosilicon compounds are prepared via transesterification of silanes which have three and/or four alkoxy groups, with diols, preferably in the presence of transesterification catalysts. The transesterification catalyst used can comprise any of the known acidic or basic catalysts, e.g. acidic or basic ion exchange resins, hydrochloric acid, Si—Cl-containing compounds, sulfuric acid, sulfonic acid derivatives, linear phosphonitrile chlorides or their reaction products with amines, strong bases or their reaction products with siloxanes, or alkoxytitanates or alkoxyzirconates. Water can optionally be added. After the reaction, the catalysts are advantageously removed or deactivated via suitable measures, e.g. via treatment with ion exchange resins and/or filtration, neutralization, treatment with metals, e.g. iron or heating. The product thus obtained can, if desired, be separated from low-molecular-weight compounds, for example, via simple distillation or by means of passage through a thin-film evaporator. The low-molecular-weight compounds can also be removed during the reaction, e.g. via distillation.

The invention further provides crosslinkable compositions which comprise organosilicon compounds containing units of formula (I), and are preferably compositions crosslinkable via a condensation reaction. For the purposes of the present invention, the term “condensation reaction” is intended to include any preceding hydrolysis step.

In addition to the inventive organosilicon compounds described above, the inventive compositions can further comprise any of the substances which are useful in compositions crosslinkable via a condensation reaction, an example being an organosilicon compound having at least two condensable groups (A), crosslinking agents (C) which differ from component (B), catalysts (D), plasticizers (E), fillers (F), adhesion promoters (G) and additives (H).

The inventive compositions are most preferably compositions comprising (A) organosilicon compound(s) having at least two condensable groups, (B) organosilicon compound(s) containing units of the formula (I), and optionally (c) crosslinking agents, (D) catalysts, (E) optionally fillers, (F) optionally adhesion promoters, (G) optionally plasticizers, and (H) optionally additives. Each of the compounds may be a single component or a plurality of components.

The organosilicon compounds (A) can be any organosilicon compound having at least two condensable groups useful in compositions crosslinkable via a condensation reaction. These can either be pure siloxanes, i.e. ≡Si—O—Si≡ structures, or else silcarbanes, i.e. ≡Si—R″—Si≡ structures R″ being a divalent hydrocarbon radical, optionally substituted or interrupted by heteroatoms, or can be copolymers having any desired organosilicon groups.

For the purposes of the present invention, the term “condensable radicals” is intended to include radicals from which condensable groups are generated in any preceding hydrolysis steps.

The organosilicon compounds (A) used according to the invention are preferably compounds containing units of the formula

R³ₐZ_{b}SiO_{(4-1-b)/2} (III),

where
R³ can be identical or different, and are optionally substituted hydrocarbon radicals which can be interrupted by oxygen atoms,
Z can be identical or different, and are a hydroxy radical or hydrolyzable radical,
a is 0, 1, 2 or 3, preferably 1 or 2, and
b is 0, 1, 2 or 3, preferably 0, 1 or 2, more preferably 0,
with the proviso that a+b is smaller than or equal to 4 and at least two condensable radicals Z are present per molecule. In organosilicon compounds (A), a+b is preferably smaller than or equal to 3.

The radical R³ is preferably a monovalent hydrocarbon radical having from 1 to 18 carbon atoms, optionally substituted by halogen atoms, amino groups, ether groups, ester groups, epoxy groups, mercapto groups, cyano groups or (poly)glycol radicals, where the latter are composed of oxyethylene units and/or oxypropylene units, and most preferably, alkyl radicals having from 1 to 12 carbon atoms, in particular the methyl radical. However, the radical R³ can also be a divalent radical which, for example, bonds two silyl groups to one another.

Examples of monovalent radicals R³ are the examples given for radical R. Examples of divalent radicals R³ are polyisobutylenediyl radicals, polymethyl methacrylatediyl radicals, polybutyl methacrylatediyl radicals and propanediyl-terminated polypropylene glycol radicals.

Examples of radicals Z are the examples given for X. Radical Z is preferably an organyloxy radical —OR¹, where R¹ is as defined above, more preferably the methoxy or ethoxy radical, in particular the methoxy radical.

Organosilicon compounds (A) are most preferably compounds of the formula

Z₃₋ᵤR³ᵤSi—O—(SiR³₂—O)ᵥ—SiR³ᵤZ₃₋ᵤ (IV),

where
each of R³ and Z has one of the definitions given above,
v is from 30 to 3000, and
u can be identical or different, and is 0, 1 or 2. in compounds (A), u is preferably 2 if Z is defined as a hydroxy group, and u is preferably 0 or 1 if R³ is other than a hydroxy group.

Examples of organosilicon compounds (A) are
(MeO)₂MeSiO[SiMe₂O]₂₀₀₋₂₀₀₀SiMe(OMe)₂,
(MeO)₂MeSiO[SiMe₂O]₂₀₀₋₂₀₀₀SiMe(OEt)₂,
(MeO)₃SiO[SiMe₂O]₂₀₀₋₂₀₀₀SiMe(OMe)₂,
(MeO)₃SiCH₂CH₂[SiMe₂O]₂₀₀₋₂₀₀₀ SiMe₂-CH₂CH₂Si(OMe)₃,
(HO)Me₂SiO[SiMe₂O]₂₀₀₋₂₀₀₀SiMe₂(OH),
(EtO)₂MeSiO[SiMe₂O]₂₀₀₋₂₀₀₀SiMe(OEt)₂,
(HO)MeViSiO[SiMe₂O]₂₀₀₋₂₀₀₀SiMeVi(OH),
(MeO)₂MeSiO[SiMe₂O]₂₀₀₋₂₀₀₀SiVi(OMe)₂,
(MeO)₂ViSiO[SiMe₂O]₂₀₀₋₂₀₀₀SiVi(OMe)₂, and
(EtO)₂ViSiO[SiMe₂O]₂₀₀₋₂₀₀₀SiVi(OEt)₂,
   where Me is the methyl radical, Et is the ethyl radical and Vi is the vinyl radical.

However, component (A) can also be silylated organic compounds having at least two condensable groups, e.g. silylated acrylates, silylated vinyl polymers, silylated polyurethanes, and silylated polyglycols. The polymers can be linear, branched or a mixture of these. The polymers can moreover contain identical or different end groups, e.g. a mixture composed of methyldimethoxysilyl and trimethoxysilyl end groups. The silylation can be carried out via known procedures, examples of these being hydrosilylation with HSi(OMe)₂(Me) at double bonds present in the polymer, an addition reaction of amino-functional silanes or siloxanes onto isocyanate-containing prepolymers, the addition reaction of isocyanate-functional silanes onto polymers containing hydroxy groups, e.g. polyglycols or copolymerization of monomers having a double bond with vinyl silanes such as vinyltrimethoxysilane or methylvinyldimethoxysilane.

The viscosity of the organosilicon compounds (A) is preferably from 100 to 10⁶ m·Pas, more preferably from 10³ to 350,000 m·Pas, in each case at 25° C. The organosilicon compounds (A) are commercially available products or can be prepared by methods familiar in silicon chemistry.

The amount of component (B) present in the inventive compositions is preferably from 0.5 to 30 parts by weight, more preferably from 2 to 15 parts by weight, based in each case on 100 parts of component (A).

The crosslinking agents (C) optionally used in the inventive compositions can be any desired crosslinking agents having at least two condensable radicals, e.g. silanes having at least two organyloxy groups, where these differ from component (B).

The crosslinking agents (C) optionally used in the inventive compositions are more preferably silane crosslinking agents such as tetramethoxysilane, tetraethoxysilane, tetrapropoxysilane, tetrabutoxysilane, methyltrimethoxysilane, dimethyldimethoxysilane, methyltriethoxysilane, methylvinyldimethoxysilane, vinyltrimethoxysilane, butyltrimethoxysilane, vinyltriethoxysilane, phenyltrimethoxysilane, diphenyldimethoxysilane, phenyltriethoxysilane, 3-cyanopropyltrimethoxysilane, 3-cyanopropyltriethoxysilane, 3-(glycidoxy)propyltriethoxysilane, 1,2-bis(trimethoxysilyl)ethane, 1,2-bis(triethoxysilyl)ethane, 3-aminopropyltrimethoxysilane, 3-(2 aminoethyl)aminopropyltrimethoxysilane, 3-(2-aminoethyl)-aminopropylmethyldimethoxysilane, O-methylcarbamatomethyltrimethoxysilane, O-methylcarbamatomethylmethyldimethoxysilane, morpholinomethyltriethoxysilane, cyclohexylaminomethyltriethoxysilane, methyltriacetoxysilane, ethyltriacetoxysilane, di-tert-butoxydiacetoxysilane, methyltris(methylethylketoximo)silane and vinyltris(methylethylketoximo)silane, or their partial hydrolyzates, which, can optionally also be prepared via cohydrolysis, e.g. via cohydrolysis of methyltrimethoxysilane and dimethyldimethoxysilane.

The crosslinking agents (C) optionally used in the inventive compositions are commercially available products or can be prepared by processes known in silicon chemistry. When the inventive compositions comprise crosslinking agents (C), the amount is preferably from 0.5 to 10 parts by weight, with particular preference from 1 to 3 parts by weight, based in each case on 100 parts by weight of component (A). The inventive compositions preferably comprise additional crosslinking agents (C).

Examples of catalysts (D) are the previously known titanium compounds and organotin compounds such as di-n-butyltin dilaurate and di-n-butyltin diacetate, di-n-butyltin oxide, dioctyltin diacetate, dioctyltin dilaurate, dioctyltin oxide and reaction products of these compounds with alkoxysilanes such as tetraethoxysilane, and also mixtures or reaction products of titanium or of tin compounds with phosphonic acids, with phosphonic esters or with phosphoric esters, preference being given to di-n-butyltin diacetate and dibutyltin oxide in tetraethyl silicate hydrolyzate, and also to mixtures or reaction products of titanium compounds or of tin compounds with phosphonic acids, with phosphonic esters or with phosphoric esters, particular preference being given to di n-butyltin oxide in tetraethyl silicate hydrolyzate, and also to mixtures or reaction products of titanium compounds or of tin compounds with alkylphosphonic acids, alkylphosphonic esters or with phosphoric esters. When the inventive compositions comprise catalyst (D) the amounts are preferably from 0.01 to 3 parts by weight, with greater preference from 0.05 to 2 parts by weight, in each case based on 100 parts by weight of constituent (A).

Examples of plasticizers (E) are dimethylpolysiloxanes which are liquid at room temperature and which are end-capped with trimethylsiloxy groups, in particular those with viscosities at 25° C. in the range from 50 to 1000 m·Pas, high-boiling hydrocarbons, e.g. paraffin oils, or dialkylbenzenes or dialkylnaphthalenes or mineral oils composed of naphthenic and of paraffinic units, or preferably, in the case of silylated organic polymers as component (A), polyglycols, in particular optionally substituted polypropylene glycols, high-boiling esters, e.g. phthalates, citric esters or diesters of dicarboxylic acids, liquid polyesters or methacrylates and also alkylsulfonic esters.

The amount of plasticizer (E) present in the inventive compositions is preferably from 0 to 300 parts by weight, with particular preference from 10 to 200 parts by weight, and in particular from 20 to 100 parts by weight, based in each case on 100 parts by weight of component (A).

Examples of fillers (F) are non-reinforcing fillers, i.e. fillers whose BET surface area is up to 50 m²/g, such as quartz, diatomaceous earth, calcium silicate, zirconium silicate, zeolite, metal oxide powders such as aluminum, titanium, iron or zinc oxides and their mixed oxides, barium sulfate, calcium carbonate, gypsum, silicon nitride, silicon carbide, boron nitride, glass powders and plastics powders such as polyacrylonitrile powder; reinforcing fillers, i.e. fillers whose BET surface area is more than 50 m²/g, such as fumed silica, precipitated silica, precipitated chalk, carbon black such as furnace and acetylene black and silicon-aluminum mixed oxides of large BET surface area; fibrous fillers, such as asbestos, and also carbon fibers. The fillers mentioned are optionally hydrophobized, for example via treatment with organosilanes or organosiloxanes, with stearic acid, or via etherification of hydroxy groups to give alkoxy groups. If fillers (F) are used, they are preferably hydrophilic fumed silica and precipitated or ground calcium carbonate.

The preferred amounts of filler (F) present in the inventive compositions is preferably from 0 to 300 parts by weight, with particular preference from 1 to 200 parts by weight, and in particular from 5 to 200 parts by weight, based in each case on 100 parts by weight of component (A).

Examples of the adhesion promoters (G) optionally used in the inventive compositions are silanes and organopolysiloxanes having functional groups, e.g. those having glycidoxypropyl, aminopropyl, aminoethylaminopropyl, ureidopropyl or methacryloxypropyl radicals, and having crosslinkable groups, e.g. methoxy radicals or ethoxy radicals. However, particularly if another component, such as organosilicon compound (A), or (B), or (C), has the functional groups mentioned, it is possible to omit any addition of adhesion promoter.

The amount of adhesion promoter (G) present in the inventive compositions is preferably from 0 to 50 parts by weight, with particular preference from 1 to 20 parts by weight, in particular from 1 to 10 parts by weight, based in each case on 100 parts by weight of component (A).

Examples of additives (H) are pigments, dyes, odorants, antioxidants, agents for influencing electrical properties such as conductive carbon black, flame retardants, heat stabilizers, light stabilizers and agents to lengthen skinning time such as silanes having an SiC-bonded mercaptoalkyl radical, cell-generating agents, e.g. azodicarbonamide, heat-stabilizers, scavengers, e.g. Si—N-containing compounds, agents with thixotropic effect, e.g. phosphoric esters, polyglycols, and organic solvents such as alkylaromatics.

The amount of additives (H) present in the inventive compositions is preferably from 0 to 100 parts by weight, more preferably from 0 to 30 parts by weight, and in particular from 0 to 10 parts by weight, based in each case on 100 parts by weight of organopolysiloxane (A).

The inventive compositions are most preferably compositions composed of (A) organosilicon compounds containing units of the formula (III), (B) organosilicon compound of the formula (II), optionally (C) crosslinking agent, optionally (D) catalyst, optionally (E) plasticizer, optionally (F) fillers, optionally (G) adhesion promoter, and optionally (H) additives.

For preparation of the inventive compositions all of the constituents may be mixed with one another in any desired sequence. This mixing can take place at room temperature and at the pressure of the ambient atmosphere, i.e. about 900 to 1100 hPa. However, this mixing can also, if desired, take place at higher temperatures, e.g. at temperatures in the range from 35 to 135° C. It is also possible to mix at reduced pressure, for example, for one or more distinct periods or continuously, e.g. at an absolute pressure of from 30 to 500 hPa, in order to remove volatile compounds or air. Each of the individual constituents of the inventive compositions can be a single type of that constituent or else a mixture of at least two different types of those constituents.

The usual water content of air is sufficient for crosslinking of the inventive compositions. Crosslinking of the inventive compositions preferably takes place at room temperature. They can also, if desired, be crosslinked at temperatures higher or lower than room temperature i.e. from −5° to 15° C. or at from 30° to 50° C. and/or using concentrations of water that exceed the normal water content of air. Crosslinking is preferably carried out at a pressure of from 100 to 1100 hPa, in particular at the pressure of the ambient atmosphere. The present invention further provides moldings produced via crosslinking of the inventive compositions.

The inventive compositions can be used for any of the purposes for which it is possible to use compositions which are storable when water is excluded but which on ingress of water crosslink at room temperature to give elastomers. Thus, the compositions are preferably substantially free of water such that premature cure during storage is prevented.

The inventive compositions therefore have excellent suitability for example as sealing compounds for joints, including joints that run vertically, and including similar cavities whose gap width is from 10 to 40 mm, e.g. in buildings, in land vehicles, in watercraft and in aircraft, or as adhesives or putty compositions e.g. in window construction or in the production of aquaria or display cases, or else, for example, for production of protective coverings, including those for surfaces having continuous exposure to fresh water or to sea water, or of antislip coverings or of elastomeric moldings, and also for insulation of electrical or electronic apparatuses.

An advantage of the inventive compositions is that they are easy to prepare and have high storage stability over a long period, and that crosslinking takes place by an environmentally compatible method. A further advantage is that the surrounding environment, i.e. the materials adjacent to the moldings produced in the specific applications, e.g. façcade joints, floor joints, and joints between structures, are not hydrophobized. A still further advantage is that droplets of water or smoothing compositions, i.e. water with surfactant, which have remained on the surface of the uncrosslinked compositions during the respective application, e.g. during the jointing of windows, do not leave any visible residue.

All of the viscosities given in the examples described below are measured at a temperature of 25° C. Unless otherwise stated, the examples below are carried out at the pressure of the ambient atmosphere, i.e. at about 1000 hPa, and at room temperature, i.e. at about 23° C., or at a temperature which becomes established without additional heating or cooling when the reactants are combined at room temperature, and at a relative humidity of about 50%. All parts and percentages are by weight, unless otherwise stated.

To assess hydrophobization (Test 1) of the surroundings, strips of a height of about 5 mm and a width of about 10 mm of the uncrosslinked sealant paste are applied to sandstone and crosslinked by storage for 7 days at 23° C. and 50% relative humidity. The samples were then sprinkled with water. The extent of hydrophobized region around the sealant is stated in mm.

To assess the residue of water droplets on the surface (Test 2) a layer having a thickness of 2 mm of each of the crosslinkable compositions were applied to PE foil and then water droplets of various sizes are immediately applied to the surface. During hardening at room temperature, the foil is stored horizontally, so that the water droplet does not move and dries slowly. After 24 hours the residue is inspected from various viewing angles from about 50 cm, and evaluated. Value 1 indicates that residue is hardly visible or invisible (as a function of viewing angle), a value of 2 indicates that a residue is clearly visible at the margin or in the center, irrespective of viewing angle, and 3 means that residue is clearly visible, irrespective of viewing angle.

Modulus is the stress value for 100% tensile strain according to DIN 53504-85 S2.

Me is a methyl radical.

### Example 1

58.5 g of 1,2-propanediol, 210 g of methyltrimethoxysilane, 134 g of hexane and 0.15 g of a 40% by weight solution of tetrabutylphosphonium hydroxide in water were stirred at from 90-110° C. for 2 hours with exclusion of humidity, and the methanol produced was removed by azeotropic distillation. The mixture was then cooled, and the product was neutralized with 3 g of acidic ion exchange resin, based on polystyrene (commercially available as “Purolite CT 169 DR” from Purolite GmbH, Germany), and drawn off through a fine filter, yielding 199 g of siloxane crosslinking agent B1. Results from ²⁹Si NMR analysis: 27.8% MeSi(OMe)₃, 47.0% MeSi(OMe)₂(—O—CH(Me)CH₂—O—)_{1/2}, 21.9% MeSi(OMe)(—O—CH(Me)CH₂—O—)_{2/2}, 2.3% MeSi(OMe)(—O—CH(Me)CH₂—O—) and 1.0% MeSi(OMe)₂O_{1/2}. Viscosity is 2.0 mm²/s, and flashpoint is 20° C.

330 g of a polydimethylsiloxane mixture in which the siloxanes are terminated by diethoxymethylsilyl groups and by dimethoxyvinylsilyl groups, and the ratio of diethoxymethylsilyl end groups to dimethoxyvinylsilyl end groups is about 1:1, with viscosity of 80,000 mPa·s, 265 g of a trimethylsilyl-end capped polydimethylsiloxane with viscosity of 1000 mPa·s, 7.5 g of methyltrimethoxysilane, 15 g of the siloxane crosslinking agent B1 prepared above, 12.5 g of a adhesion promoter prepared via reaction of 1 part of aminopropyltriethoxysilane with 1 part of methyltriethoxysilane hydrolyzate with ethoxy content of 37%, and 4.5 g of aminopropyltrimethoxysilane are mixed with one another in a planetary mixer and stirred for 15 minutes. The mixture is then completed by homogeneously incorporating 63 g of fumed silica with a specific surface area of 150 m²/g (commercially available as HDK® V15 from Wacker Chemie AG), 1.1 g of octylphosphonic acid, 1.4 g of a polyoxyethylene-polyoxypropylene diol copolymer with a viscosity of 700 mPa·s, and 2.5 g of a tin catalyst prepared via reaction of di-n-butyltin diacetate and tetraethoxysilane. Finally, the mixture is stirred for 5 minutes at about 100 mbar absolute pressure, and drawn off with exclusion of air, and stored.

Test 1 and Test 2 were performed on the resultant composition. The results are presented in Table 1.

The resultant composition was applied at a thickness of 2 mm to a PE foil and stored at 23° C./50% rel. humidity. After 7 days of hardening, the modulus was determined. The modulus is also presented in Table 1.

### Comparative Example 1 (CE1)

The procedure described in inventive example 1 is repeated except that 14 g of methyltrimethoxysilane are used instead of 15 g of siloxane crosslinking agent B1.

Table 1 gives the results.

### Comparative Example 2 (CE2)

The procedure described in inventive example 1 is repeated, except that 33 g of a methyltrimethoxysilane hydrolyzate with methoxy content of 29.0%, are used instead of 15 g of siloxane crosslinking agent B1. Table 1 gives the results.

TABLE 1

| | | Hydrophobization | |
|---|---|---|---|
| | Residue of water | of environment | |
| Example | droplets (Test 2) | (Test 1) in mm | Modulus N/mm² |
| 1 | 1 | <1 | 0.40 |
| CE1 | 3 | 5-6 | 0.39 |
| CE2 | 1-2 | <1 | 0.44 |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An organosilicon compound comprising units of the formula
R_{d}XₑSiY_{(4-d-e)/2} (I),
where
R are identical or different, and are monovalent, optionally substituted hydrocarbon radicals optionally interrupted by oxygen atoms,
X are identical or different, and are hydroxy groups or monovalent, hydrolyzable radicals,
Y are identical or different, and are —O— or a difunctional hydrolyzable radical,
d is 0, 1, 2 or 3, and
e is 0, 1, 2 or 3,
with the proviso that d+e≦3, from 2 to 100 units of the formula (I) are present per molecule, and at least 1 radical Y which is a difunctional hydrolyzable radical and at least one radical X are present per molecule.

2. The organosilicon compound of claim 1, of the formula
[X_{g}R_{3-g}SiY_{1/2}—]ₚ[XᵢR₂₋ᵢSiY_{2/2}—]_{q}[XₘR₁₋ₘSiY_{3/2}—]ᵣ[SiY_{4/2}—]ₛ (II)
where
g is 0, 1, 2 or 3,
i is 0, 1 or 2,
m is 0 or 1,
p is 0 or a whole number from 1 to 10,
q is 0 or a whole number from 1 to 90,
r is 0 or a whole number from 1 to 10, and
s is 0 or a whole number from 1 to 10,
with the proviso that (p+q+r+s) is a number from 2 to 100, the distribution of the units is optionally random, and at least one radical Y which is a difunctional hydrolyzable radical and at least one radical X are present per molecule.

3. The organosilicon compound of claim 1, wherein the radical Y is —O— or a divalent organyloxy radical —OR²O—, where R² is a divalent, optionally substituted hydrocarbon radical, optionally interrupted by oxygen atoms.

4. The organosilicon compound of claim 2, wherein the radical Y is —O— or a divalent organyloxy radical —OR²O—, where R² is a divalent, optionally substituted hydrocarbon radical, optionally interrupted by oxygen atoms.

5. A crosslinkable composition comprising an organosilicon compound of claim 1.

6. The crosslinkable composition of claim 5, which is a composition crosslinkable via a condensation reaction.

7. The crosslinkable composition of claim 5, which is a composition comprising
(A) at least one organosilicon compound having at least two condensable groups,
(B) at least one organosilicon compound containing units of the formula (I), and optionally,
(C) one or more crosslinking agents,
(D) one or more catalysts,
(E) one or more fillers,
(F) one or more adhesion promoters,
(G) one or more plasticizers, and
(H) one or more additives different from (C) through (G).

8. The crosslinkable composition of claim 7, which is a composition comprising
(A) at least one organosilicon compound having at least two condensable groups,
(B) at least one organosilicon compound containing units of the formula (I),
(C) optionally, one or more crosslinking agents,
(D) one or more condensation catalysts,
(E) optionally, filler(s),
(F) optionally, adhesion promoter(s),
(G) optionally, plasticizer(s), and
(H) optionally, additives.

9. The crosslinkable composition of claim 7, which comprises an amount of organosilicon compound (B) of from 0.5 to 30 parts by weight, based on 100 parts by weight of component (A).

10. The crosslinkable composition of claim 7, which is a composition consisting of
(A) at least one organosilicon compound containing units of the formula (III),
(B) at least one organosilicon compound of the formula (II),
(C) optionally, a crosslinking agent,
(D) optionally, a catalyst,
(E) optionally, a plasticizer,
(F) optionally, a filler,
(G) optionally, an adhesion promoter, and
(H) optionally, further additives.

11. A process for preparation of the crosslinkable compositions of claim 7, comprising mixing of all of the constituents in any desired sequence.

12. A molding, produced via crosslinking of a composition of claim 5.
